(19) United States
(12) Patent Application Publication
(10) Pub. No.: US 2025/0331516 A1
(43) Pub. Date: Oct. 30, 2025

(54) CITRIC ACID AND LACTIC ACID DISINFECTING SOLUTION FOR SOFT POROUS SURFACES

(71) Applicant: The Clorox Company, Oakland, CA (US)

(72) Inventors: Schavel Morrison-Gerry, Pleasanton, CA (US); Nipa Modi, Pleasanton, CA (US)

(21) Appl. No.: 18/651,043

(22) Filed: Apr. 30, 2024

(51) Int. Cl. A01N 37/04; A01N 25/30; A01N 37/10; A01P 1/00

(52) U.S. Cl. CPC A01N 37/04; A01N 25/30; A01N 37/10; A01P 1/00

(57) ABSTRACT

Disclosed are cleaning formulations. The cleaning formulation may include (i) about 1% to about 5% by weight of citric acid, (ii) about 0.1% to about 2% by weight of lactic acid, (iii) about 0.01% to about 1% by weight of a preservative, and (iv) about 0.1% to about 5% by weight of at least one non-ethoxylated surfactant. The cleaning formulation may further include one or more of the following non-limiting adjuncts: solvents, fragrances, preservatives, water, pH adjusting agents or any mixture or combination thereof. The ratio of citric acid to lactic acid in the cleaning formulation may be about 3:1 to 5:1. Additionally, the cleaning formulation may exhibit at least a 3-log reduction in a Staphylococcus aureus population within 10 minutes, as tested on a soft, porous surface. Hard surface sanitization and/or disinfection may also be provided.

### BACKGROUND OF THE INVENTION

### 1. The Field of the Invention

The present invention relates to a cleaning or sanitizing and disinfecting formulation for use against bacteria, viruses, and/or other microbes. In particular, the formulation can be suitable for providing disinfection of soft, porous surfaces (e.g., upholstery, carpets, clothing, etc.). Disclosed embodiments may exhibit at least a 3-log reduction in a Staphylococcus aureus population within 10 minutes.

### 2. Description of Related Art

Cleaning formulations are commercially available and widely used. However, it is difficult for a given formulation to provide an equivalent level of disinfection to both hard non-porous surfaces, as well as soft, porous surfaces. This is particularly difficult where the formulation is to be limited to an “approachable” chemistry (e.g., avoidance of high actives concentrations, and/or harsh active agents), in the form of a disinfecting spray. For example, traditional multi-surface disinfecting sprays generally contain biocides such as quats and a high concentration of ethanol (e.g., 58%) to achieve similar disinfection results on hard surfaces as well as soft porous surfaces.

For example, typically available multi-surface disinfecting sprays can achieve disinfection of hard non-porous surfaces but only achieve a lower “sanitization” level of efficacy on soft, porous surfaces. In addition, while there are many actives that can be used for hard surface disinfection, there are significantly less actives available that are both efficacious and compatible with soft surfaces. As such, products that do disinfect soft, porous surfaces generally contain harsher chemicals with high levels of actives. It would be advantageous to provide a formulation that could achieve disinfection of both hard and soft surfaces, while avoiding harsh active agents, while only employing relatively low levels of actives.

### BRIEF SUMMARY

The present disclosure relates to formulations and associated methods of treating various surfaces (e.g., including soft, porous surfaces) to provide disinfection, sanitization, or other cleaning treatment. The present formulations may include both citric acid and lactic acid. Applicant has surprisingly found that inclusion of such a combination, particularly when combined with specific selection criteria relative to surfactants, preservatives, and/or other adjuncts, can provide for a high log reduction against desired target microbes, even on soft, porous surfaces. Such log reductions are also possible on other surfaces, such as hard non-porous surfaces, which are typically more easily sanitized or disinfected.

An embodiment of the present disclosure relates to a cleaning formulation (e.g., a sanitizing and/or disinfecting formulation) including: (i) about 1% to about 5% by weight of citric acid; (ii) about 0.1% to about 2% by weight of lactic acid; (iii) about 0.01% to about 1% by weight of a preservative; (iv) about 0.1% to about 5% by weight of at least one non-ethoxylated surfactant; and (v) optionally, one or more of the following adjuncts: solvents, fragrances, preservatives, water, pH adjusting agents or any mixture or combination thereof. In an embodiment, the ratio of citric acid to lactic acid is about 3:1 to about 5:1 and the cleaning formulation exhibits at least a 3-log reduction in a Staphylococcus aureus population within 10 minutes.

Another embodiment of the present disclosure relates to a cleaning formulation (e.g., a sanitizing and/or disinfecting formulation) including: (i) about 2% to about 4% by weight of citric acid; (ii) about 0.1% to about 1% by weight of lactic acid; (iii) about 0.01% to about 1% by weight of a benzoic acid or salt thereof; (iv) about 0.1% to about 5% by weight of a nonionic, non-ethoxylated surfactant; and (v) optionally, one or more of the following adjuncts: solvents, fragrances, preservatives, water, pH adjusting agents or any mixture or combination thereof. In an embodiment, the ratio of citric acid to lactic acid is about 3:1 to about 5:1 and the cleaning formulation exhibits at least a 3-log reduction in a Staphylococcus aureus population within 10 minutes.

Another embodiment of the present disclosure relates to a cleaning formulation including: (i) about 2% to about 4% by weight of citric acid; (ii) about 0.2% to about 1% by weight of lactic acid; (iii) about 0.1% to about 0.8% by weight of a benzoic acid or salt thereof; (iv) about 0.1% to about 5% by weight of a non-ethoxylated surfactant; (v) about 2% to about 10% by weight of a solvent; and (vi) optionally, one or more of the following adjuncts: fragrances, preservatives, water, pH adjusting agents or any mixture or combination thereof. In an embodiment, the ratio of citric acid to lactic acid is about 3:1 to about 5:1 and the cleaning formulation exhibits at least a 3-log reduction in a Staphylococcus aureus population within 10 minutes.

Exemplary methods of treatment may include providing any cleaning formulation as described herein, and contacting a surface (e.g., a soft porous surface) with such composition for a given period of time, to achieve a desired result (e.g., a desired threshold log reduction in a target microbe such as Staphylococcus aureus population within a given time frame.

In any of the described embodiments, the pH can be from about 2 to about 5.

In any of the described embodiments, the non-ethoxylated surfactant can include a nonionic surfactant.

In any of the described embodiments, the non-ethoxylated surfactant can include an anionic surfactant.

In any of the described embodiments, the non-ethoxylated surfactant can include an amphoteric surfactant.

In any of the described embodiments, the non-ethoxylated surfactant can include a sulfate.

In any of the described embodiments, the non-ethoxylated surfactant can include an amine oxide.

In any of the described embodiments, the cleaning composition can exhibit at least a 4-log reduction, or at least a 5-log reduction in a Staphylococcus aureus population within 10 minutes.

In any of the described embodiments, the preservative can include sodium benzoate.

In any of the described embodiments, the cleaning composition can exhibit at least a 3-log reduction in a Staphylococcus aureus population on both hard (e.g., hard non-porous) and soft (e.g., soft, porous) surfaces within 10 minutes.

In any of the described embodiments, the cleaning composition can exhibit at least a 4-log reduction, or at least a 5-log reduction in a Staphylococcus aureus population on both hard and soft surfaces within 10 minutes.

In any of the described embodiments, the nonionic, non-ethoxylated surfactant can include an alkyl polyglucoside.

In any of the described embodiments, the non-ethoxylated surfactant may comprise at least one of, or may be selected from the group consisting of: alkyl polyglucosides, amine oxides, sulfates, and any combinations or mixtures thereof.

In any of the described embodiments, the solvent may comprise at least one of, or may be selected from the group consisting of: alcohols, diols and any mixture or combination thereof.

In any of the described embodiments, the formulation may include a significant fraction of water, such as at least 40%, at least 45%, at least 50% at least 55%, at least 60%, at least 65%, at least 70%, at least 75%, at least 80%, at least 85%, at least 90% at least 95%, at least 96%, at least 97%, or at least 98% water. In some embodiments, water may be present at no more than 95%, no more than 90%, no more than 85%, or no more than 80% water. Such water may be present in free, unbound form.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

The formulation as described herein may provide sanitization, disinfection, or sterilization, other cleaning, or other treatment. As used herein, the term “sanitize” shall mean the reduction of “target” contaminants in the inanimate environment to levels of at least 3 logs below the untreated condition, or that reduces a “target” bacterial population by significant numbers where public health requirements have not been established. By way of example, an at least 99% reduction in bacterial population within a 24-hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, within 1 minute, or within 30 seconds), when sanitizing or disinfecting.

As used herein, the term “disinfect” shall mean the elimination of at least 6 logs of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Some embodiments may provide for at least a 2 or more-log reduction (e.g., 3-log reduction, 4-log reduction, 5-log reduction, or 6-log reduction) in a bacterial or other target microbe population within a designated time period (e.g., 10 minutes, 5 minutes, 4 minutes, 3 minutes, 2 minutes, 1 minute, 30 seconds, or the like) relative to a baseline. A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus aureus. It will be appreciated that antimicrobial efficacy can also be achieved against other target microbes, numerous examples of which will be apparent to those of skill in the art.

The term “Safer Choice” means the U.S. EPA program that is focused on identifying safer sanitizing and disinfecting active ingredients. The EPA has a special approval process for products that meet the Safer Choice criteria. The EPA, as part of the Safer Choice program has identified certain active ingredients that are approved for cleaning products and authorized to use the Safer Choice logo. Products that have been approved may be found under https://www.epa.gov/pesticide-labels/design-environment-logo-antimicrobial-pesticide-products#authorizeddfe. Approved products must have only ingredients that meet the “Safer Choice Standard” according to https://www.epa.gov/pesticide-labels/design-environment-logo-antimicrobial-pesticide-products#approved and https://www.epa.gov/saferchoice/safer-choice-standard. The above EPA publications are herein incorporated by reference in their entirety.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Reference to ASTM or other standards or standardized tests refers to the latest version of such standard, unless otherwise specified. Standards referenced herein are herein incorporated by reference in their entirety.

### II. Exemplary Cleaning Formulations

In an aspect, the present invention is directed to a cleaning formulation (e.g., a sanitization and/or disinfection formulation). The formulation may include a synergistic combination of citric acid and lactic acid. One or more of a preservative or a non-ethoxylated surfactant may also be present. Water is typically present. Additionally, the formulation may include one or more adjuncts such as, but not limited to solvents, fragrances, or pH adjusting agents. The formulation may advantageously include a ratio of citric acid to lactic acid of about 3:1 to about 5:1. The cleaning formulation may exhibit at least a 3-log reduction in a Staphylococcus aureus population within 10 minutes. In addition to efficacy against Staphylococcus aureus, the present formulations may also be effective against other microbial targets that may include various viruses (e.g., Influenza A (H1N1), Rhinovirus Type-39, phi 6, SARS-Covid surrogates, MS2) and other pathogenic bacteria or fungi (e.g., Candida auris, Klebsiella pneumonia, Pseudomonas aeruginosa (Pseudo), A. niger etc.).

### A. Citric Acid and Lactic Acid

Rather than employing strong oxidants such as peroxide, hypochlorites, or other harsh antimicrobial agents (e.g., quaternary amines, aromatic alcohols, phenolic antimicrobial agents, very high alcohol concentrations), the present formulations include more “approachable” mild actives, to achieve sanitization and/or disinfection. In at least some embodiments, the formulation may be free of such components, which are pungent, cause irritation to skin and other tissues, damage soft surfaces, etc. Rather, and in particular, a combination of citric acid and lactic acid can be employed. In some embodiments, the citric acid is included in the cleaning formulation from about 0.5%, from 1%, from 1.5%, from 2%, up to 10%, up to 8%, or up to 5% by weight. In some embodiments, the lactic acid is included in the cleaning formulation from about 0.05%, from 0.1%, from 0.2%, from 0.3%, from 0.4%, from 0.5%, from 1%, from 2%, up to 10%, up to 8%, up to 5%, up to 3%, or up to 2% by weight. More particularly, particularly advantageous and synergistic results can be obtained where the citric acid is present in an amount of from about 1% to about 5%, or from about 2% to about 4% by weight of the formulation. Particularly advantageous and synergistic results can be obtained where the lactic acid is present in an amount of from about 0.1% to about 2%, or from about 0.1% to about 2%, or from about 0.2% to about 1% by weight of the formulation.

In some embodiments, there exists a synergy between citric acid and lactic acid which occurs due to the ratio of citric acid to lactic acid. The ratio may be such that more citric acid is present than lactic acid, so as to be greater than a 1:1 ratio, or even greater than a 2:1 ratio, such as about 3:1, about 4:1, or about a 5:1 ratio of citric acid to lactic acid. In an embodiment, the ratio of citric acid to lactic acid may range from about 3:1 to about 5:1. As illustrated within the working examples, the citric acid to lactic acid ratio (and/or amounts of each) can be an important lever for achieving the desired efficacy of the cleaning formulation.

### B. Surfactants

Those of skill in the art will appreciate that any among a wide variety of surfactants (e.g., anionic, cationic, nonionic, zwitterionic, and/or amphoteric) may be suitable for inclusion in the formulation, as desired, so long as the resulting cleaning formulation can meet the stated antimicrobial efficacy standards. In an embodiment, ethoxylated surfactants are to be avoided, such that non-ethoxylated surfactants may be particularly advantageous. Other alkoxylated surfactants (e.g., propoxylated) surfactants may similarly be avoided. For example, in some embodiments, the non-ethoxylated surfactant may comprise a nonionic surfactant, an anionic surfactant, or an amphoteric surfactant. Cationic surfactants, such as quaternary amines, employed either as surfactants and/or antimicrobial agents, may be entirely or substantially absent. Non-limiting examples of suitable surfactants may include sulfates, amine oxides, alkyl polyglucosides, or any combinations or mixtures thereof.

In some embodiments, the at least one non-ethoxylated surfactant may be present from 0.01%, from 0.05%, from 0.1%, from 0.2%, from 0.3%, from 0.5%, up to 15%, up to 10%, up to 5%, up to 4%, up to 3%, up to 2%, or up to 1% by weight of the formulation. More particularly and advantageously, the surfactant may be present in an amount of from 0.1% to about 5% by weight of the formulation. Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Examples of nonionic surfactants include, but are not limited to, alkyl phosphine oxides, alkyl glucosides (i.e., alkyl glycosides) and alkyl pentosides, alkyl glycerol esters, C₆-C₂₂ linear or branched aliphatic primary or secondary alcohols, and C₂-C₈ linear or branched aliphatic glycols. Capped nonionic surfactants in which the terminal hydroxyl group is replaced by halide; C₁-C₈ linear, branched, or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters may also be useful nonionic surfactants. Other suitable nonionic surfactants may include amines of the formula R¹NR²R³ wherein R¹ is a C₅-C₃₁ linear or branched alkyl group and R² and R³ are C₁-C₄ alkyl, or C₁-C₄ hydroxyalkyl. As noted, in an embodiment, any included nonionic surfactant is not alkoxylated (e.g., ethoxylated).

Alkylpolysaccharide nonionic surfactants are disclosed in U.S. Pat. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R²O(CnH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Phosphate ester surfactants may also be suitable. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

Zwitterionic or amphoteric surfactants may be suitable. As zwitterionic or amphoteric surfactants include both a positive and negative functional group, they may also be classified as nonionic surfactants. Many such zwitterionic or amphoteric surfactants contain nitrogen. Examples of such include amine oxides, sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethylamine oxide), C₈-C₁₈ alkyl morpholine oxide (e.g. laurylmorpholine oxide), tetra-alkyl diamine dioxides (e.g. tetramethyl hexanane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) are examples of zwitterionic or amphoteric surfactants, available from Stepan Co.

In an embodiment, the employed amphoteric surfactants may exhibit cationic behavior, at the particularly employed pH values (e.g., less than about 7, greater than about 1, greater than 2, such as from about 1 to about 6, from about 2 to about 5, or about 3 to about 4). Such surfactants provide the benefits of a cationic surfactant, while allowing the composition to be free of cationic surfactants (e.g., void of quaternary amines).

Non-limiting examples of anionic surfactants include alkyl sulfates (e.g., C₈-C₁₈ linear or branched alkyl sulfates such as sodium lauryl sulfate (SLS), and sodium tetradecylsulfate), alkyl sulfonates (e.g., C₆-C₁₈ linear or branched alkyl sulfonates such as sodium octane sulfonate and secondary alkane sulfonates, fatty acids and fatty acid salts (e.g., C₆-C₁₆ fatty acid soaps such as sodium laurate), alkyl amino acid derivatives, and texapon. Other examples may include sulfate derivatives of alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methyl-sulfonates, C₆-C₁₈ alkyl, aryl, or alkylaryl ether carboxylates, sulfonated alkyldiphenyloxides (e.g. sodium dodecyldiphenyloxide disulfonate), and the like. As stated, the formulation may be free, or substantially free of any ethoxylated or other alkoxylated surfactants. In addition to causing damage to fabric and other soft surfaces, such components have been found by applicant to have a negative effect on antimicrobial efficacy.

More specific examples of nonionic and/or zwitterionic or amphoteric surfactants include lauryl dimethyl amine oxide (Ammonyx LO), also known as lauramine oxide, myristyl dimethyl amine oxide (Ammonyx MO), decylamine oxide (Ammonyx DO), other amine oxides, any betaines, alkyl polyglucosides, natrasense, and combinations thereof.

### C. Solvents

In some embodiments, a solvent other than water may be present, such as an alcohol or glycol ether solvent. Exemplary glycol ether solvents include, but are not limited to, ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di-or tri-polypropylene glycol methyl or ethyl or propyl or butyl ether, propylene glycol phenyl ether, ethylene glycol phenyl ether, acetate and/or propionate esters of glycol ethers. A solvent may be included from 0.1%, from 0.2%, from 0.3%, from 0.5%, from 15%, up to 10%, up to 8%, up to 5%, up to 3%, up to 2%, or up to 1% by weight of the formulation.

In an embodiment, the composition may be free, or substantially free of lower alcohols (e.g., C₁-C₄). Where alcohols are present, the alcohol may be a primary alcohol (e.g., ethanol), or another lower alcohol, or a diol, such as a short to medium chain diol (e.g., C₃-C₈) but not limited to 1,2 propanediol, 1,3 propanediol, 1,2 hexanediol, and/or a terpenoid diol such as p-Menthane-3,8-diol. Various embodiments may benefit from limiting or excluding altogether various volatile lower alcohols and similar VOCs. Where lower alcohols are present, they may be present in the amounts noted above relative to solvents generally, e.g., less than 50%, less than 40%, less than 30%, less than 20%, less than 10%, less than 5%, less than 3%, less than 2%, particularly in an amount of less than 1%, less than 0.8%, no greater than 0.6%, or no greater than 0.5% by weight of the formulation.

### D. Preservatives

In some embodiments, the cleaning formulation includes at least one preservative. In an embodiment, the preservative is included from about 0.005%, from 0.01%, from 0.05%, or from 0.1%, up to about 2%, up to about 1%, up to about 0.8%, or up to about 0.5% by weight of the formulation.

Preservatives may include but are not limited to benzoic acid or a benzoic acid salt such as sodium benzoate. Sorbates (e.g., potassium sorbate) may also serve as a preservative. Other exemplary preservatives may include mildewstats or bacteriostats, methyl, ethyl and propyl parabens, short chain organic acids (e.g., acetic, and/or glycolic acids), bisguanidine compounds (e.g., Dantagard and/or Glydant) and/or short chain lower alcohols (e.g., ethanol and/or IPA). Exemplary mildewstats or bacteriostats (including non-isothiazolone compounds) include but are not limited to Kathon GC, a 5-chloro-2-methyl-4-isothiazolin-3-one, Kathon ICP, a 2-methyl-4-isothiazolin-3-one, and a blend thereof, and Kathon 886, a 5-chloro-2-methyl-4-isothiazolin-3-one, all available from Rohm and Haas Company; Bronopol, a 2-bromo-2-nitropropane-1,3-diol, from Boots Company Ltd.; Proxel CRL, a propyl-p-hydroxybenzoate, from ICI PLC; Nipasol M, an o-phenyl-phenol, Na+ salt, from Nipa Laboratories Ltd.; Dowicide A, a 1,2-Benzoisothiazolin-3-one, from Dow Chemical Co.; and Irgasan DP 200, a 2,4,4′-trichloro-2-hydroxydiphenylether, from Ciba-Geigy A. G.

### E. Additional Adjuncts

The formulation may optionally include and/or be used in combination with one or more additional adjuncts. Such adjuncts include, but are not limited to, fragrances, colorants, polymers, pH adjusting agents, waxes, solubilizing materials, stabilizers, thickeners, defoamers, hydrotropes, buffers, builders, lotions and/or mineral oils, enzymes, cloud point modifiers, and/or chaotropic agents. In one embodiment, buffering and pH adjusting agents, when used, include, but are not limited to, organic acids, mineral acids, alkali metal and alkaline earth salts of citrate, silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and/or 2-amino-2methylpropanol.

A buffering agent can be a low molecular weight, organic or inorganic material used for maintaining the desired pH. For buffers that can be used, see Mccutcheon's EMULSIFIERS AND DETERGENTS, North American Edition, 1997, Mccutcheon Division, M C Publishing Company which is incorporated herein by reference. In yet another and/or alternative embodiment, solubilizing materials, when used, can include, but are not limited to, hydrotropes (e.g., water soluble salts of low molecular weight organic acids such as the sodium and/or potassium salts of xylene sulfonic acid). In an embodiment, the pH of the cleaning formulation is less than about 7, greater than about 1, greater than 2, such as from about 1 to about 6, from about 2 to about 5, or about 3 to about 4.

Thickeners, when used, include, but are not limited to, polyacrylic acid, xanthan gum, calcium carbonate, aluminum oxide, alginates, guar gum, methyl, ethyl, clays, and/or propylhydroxycelluloses. Polyacrylic acid is also an exemplary polymer adjunct. In yet another and/or alternative embodiment, defoamers, when used, include, but are not limited to, silicones, aminosilicones, silicone blends, and/or silicone/hydrocarbon blends.

While the optional addition of thickeners is noted, in an embodiment, the formulation is of relatively low viscosity, such as less than about 1000 cps, less than about 500 cps, less than about 100 cps, such as from about 1 cps to about 100 cps. Such low viscosity can aid in achieving the described antimicrobial efficacy.

In some respects, the cleaning formulation may exhibit at least a 3-log reduction against a target microbe. In yet other embodiments, the cleaning formulation may exhibit at least a 4-log or at least a 5-log reduction against a target microbe. The target microbe may be Staphylococcus aureus. Additional exemplary target microbes include but are not limited to Influenza A (H1N1), Rhinovirus type 39 or any of a wide variety of other pathogenic microbes or surrogate microbes. The formulation may exhibit such a log reduction against the target microbe within a very short exposure time frame, such as within 10 minutes, or within 5 minutes, even on a soft porous surface. The cleaning formulation may exhibit at least a 3-log reduction or at least a 4-log or a 5-log reduction against a target microbe population on both hard and soft surfaces.

### IV. EXAMPLES

Exemplary formulations and testing data are shown below in Tables 1-13. For each numerical table, table A includes formulation details while tables B and C include testing data. Unless stated otherwise, the cleaning formulations were tested against Staph. aureus on a 1×1 inch piece of 100% cotton. To pass the test, the log reduction should be at least 6.10 against Staph. aureus during the specified contact time. Results are shown as either quantitative or qualitative results.

TABLE 1A

| | Formula AC1606 | | | | | | | |
|---|---|---|---|---|---|---|---|---|
| | | | | | | | | Benchmark |
| | A | B | C | E | F | G | H | Hygenix Base |
| Ingredient | % w/w | % w/w | % w/w | % w/w | % w/w | % w/w | % w/w | % w/w |
| DI Water | to 100 | to 100 | to 100 | to 100 | to 100 | to 100 | to 100 | to 100 |
| Sodium Citrate | 0.3 | 0.5 | 0.3 | 0.3 | 0.3 | 0.3 | 0.3 | N/A |
| Dihydrate | | | | | | | | |
| Citric Acid | 0.6 | 1 | 1 | 1 | 1 | 1 | 1 | 0.3 |
| C8-10 Alkyl | 1.5 | 1.5 | 1.5 | 1.5 | 1.5 | 1.5 | 1.5 | N/A |
| Polyglucoside | | | | | | | | |
| 1,3 Propanediol | 2 | 2 | 2 | 8 | 2 | 2 | 2 | N/A |
| Ethanol | 0.5 | 0.5 | 0.5 | 0.5 | 0.5 | 0.5 | 0.5 | N/A |
| 1,2 Hexanediol | 0 | 0 | 1 | 0 | 0 | 0 | 0 | N/A |
| Potassium Sorbate | 0 | 0 | 0 | 0 | 0.2 | 0 | 0 | N/A |
| Sodium Benzoate | 0 | 0 | 0 | 0 | 0 | 0.25 | 0 | N/A |
| p-Menthane-3,8- | 0 | 0 | 0 | 0 | 0 | 0 | 0.25 | N/A |
| diol | | | | | | | | |
| Fragrance | 0.35 | 0.35 | 0.35 | 0.35 | 0.35 | 0.35 | 0.35 | 0 |
| pH | 3.63 | 3.19 | 3.16 | 3.26 | 3.59 | 3.53 | 3.19 | 1.91 |

TABLE 1B

| | Contact | | Control | Log₁₀ |
|---|---|---|---|---|
| Formula AC1606 | Time | Soil | Carrier | Reduction |
| AC1606-A | 9 min | 5% FBS | 5.31 Log₁₀ | 1.36 Log₁₀ |
| AC1606-B | 9 min | 5% FBS | 5.31 Log₁₀ | 1.89 Log₁₀ |
| AC1606-C | 9 min | 5% FBS | 5.31 Log₁₀ | 2.83 Log₁₀ |
| AC1606-E | 9 min | 5% FBS | 6.22 Log₁₀ | 2.09 Log₁₀ |
| AC1606-F | 9 min | 5% FBS | 6.22 Log₁₀ | 2.16 Log₁₀ |
| AC1606-G | 9 min | 5% FBS | 6.22 Log₁₀ | 3.71 Log₁₀ |
| AC1606-H | 9 min | 5% FBS | 6.22 Log₁₀ | 2.02 Log₁₀ |
| Benchmark - | 9 min | 5% FBS | 6.22 Log₁₀ | 2.55 Log₁₀ |
| Hygenix Base | | | | |

Tables 1A and 1B illustrate exemplary cleaning formulations AC1606 A-H as well as a a Hygenix Base—Benchmark. More details regarding the Hygenix Base formulation used as a comparison can be found in U.S. Pat. No. 10,278,393 to Bobbert, which is herein incorporated by reference in its entirety.

As shown in Table 1A, cleaning formulations AC1606 A-H include citric acid in a percentage by weight between about 0.6% to about 1% as the primary active. No lactic acid is present. Some of cleaning formulations AC1606 F-H include potassium sorbate, sodium benzoate, and/or as p-menthane-3,8-diol as additional components as shown.

Table 1B shows antimicrobial efficacy results when testing the cleaning formulations AC1606 A-H and the benchmark formulation against Staph. aureus. As shown, each formulation failed and did not achieve the desired threshold level of soft surface disinfection within the 9 minute contact time.

TABLE 2A

| | Formula AC1607 | | | |
|---|---|---|---|---|
| | A | B | C | D |
| Ingredient | % w/w | % w/w | % w/w | % w/w |
| DI Water | to 100 | to 100 | to 100 | to 100 |
| Sodium Citrate Dihydrate | 0.1 | 0.1 | 0.1 | 0.1 |
| Citric Acid | 1 | 1 | 1 | 1 |
| C8-10 Alkyl Polyglucoside | 2.5 | 2.5 | 2.5 | 2.5 |
| 1,3 Propanediol | 5 | 5 | 8 | 5 |
| Ethanol | 0.5 | 0.5 | 0.5 | 0.5 |
| 1,2 Hexanediol | 0 | 0 | 0 | 1 |
| Potassium Sorbate | 0 | 0.3 | 0.5 | 0 |
| Sodium Benzoate | 0.5 | 0.3 | 0.2 | 0.5 |
| Fragrance | 0.35 | 0.35 | 0.35 | 0.35 |
| pH | 3.61 | 3.75 | 3.86 | 3.64 |

TABLE 2B

| | Contact | | Control | Log₁₀ |
|---|---|---|---|---|
| Formula AC1607 | Time | Soil | Carrier | Reduction |
| AC1607-A | 9 min | 5% FBS | 6.19 Log₁₀ | 2.57 Log₁₀ |
| AC1607-B | 9 min | 5% FBS | 6.19 Log₁₀ | 3.84 Log₁₀ |
| AC1607-C | 9 min | 5% FBS | 6.19 Log₁₀ | 3.07 Log₁₀ |
| AC1607-D | 9 min | 5% FBS | 6.19 Log₁₀ | 3.79 Log₁₀ |

As shown in Table 2A, cleaning formulations AC1607 A-D include citric acid at 1% as the primary active antimicrobial component. No lactic acid was present. Additionally, cleaning formulations AC1607 A-D include various additional components as shown.

Table 2B shows antimicrobial efficacy results when testing the cleaning formulations AC1607 A-D against Staph. aureus. As shown, each formulation failed and did not achieve the desired threshold level of soft surface disinfection within the 9-minute contact time.

TABLE 3A

Formula AC1611

| | A | B | C | D |
|---|---|---|---|---|
| Ingredient | % w/w | % w/w | % w/w | % w/w |
| DI Water | to 100 | to 100 | to 100 | to 100 |
| Sodium Citrate | 0.3 | 0.3 | 1 | 0.5 |
| Dihydrate | | | | |
| Citric Acid | 1.5 | 1.5 | 1.5 | 2 |
| C8-10 Alkyl | 2 | 2 | 2 | 2 |
| Polyglucoside | | | | |
| 1,3 Propanediol | 10 | 10 | 10 | 10 |
| Ethanol | 0.5 | 0.5 | 0.5 | 0.5 |
| Potassium Sorbate | 0 | 0.2 | 0 | 0 |
| Sodium Benzoate | 0.5 | 0.3 | 0.5 | 0.25 |
| Fragrance | 0.35 | 0.35 | 0.35 | 0.35 |
| pH | 3.51 | 3.55 | 4.00 | 3.26 |

TABLE 3B

| | Contact | | Control | Log₁₀ |
|---|---|---|---|---|
| Formula AC1607 | Time | Soil | Carrier | Reduction |
| AC1611-A | 9 min | 5% FBS | 5.31 Log₁₀ | 3.51 Log₁₀ |
| AC1611-B | 9 min | 5% FBS | 5.31 Log₁₀ | 4.09 Log₁₀ |
| AC1611-C | 9 min | 5% FBS | 5.31 Log₁₀ | 3.26 Log₁₀ |
| AC1611-D | 9 min | 5% FBS | 5.31 Log₁₀ | 3.86 Log₁₀ |

As shown in Table 3A, cleaning formulations AC1611 A-D include from 1.5% to 2% citric acid. No lactic acid was present. Additionally, cleaning formulations AC1607 A-D include various additional adjuncts as shown.

Table 3B shows antimicrobial efficacy results when testing the cleaning formulations AC1611 A-D against Staph. aureus. As shown, each formulation failed and did not achieve the desired threshold level of soft surface disinfection within the 9-minute contact time.

TABLE 4A

| | Formula AC1612 | | | | | | | |
|---|---|---|---|---|---|---|---|---|
| | A | B | C | D | E | F | G | H |
| Ingredient | % w/w | % w/w | % w/w | % w/w | % w/w | % w/w | % w/w | % w/w |
| DI Water | to 100 | to 100 | to 100 | to 100 | to 100 | to 100 | to 100 | to 100 |
| Sodium Citrate Dihydrate | 0.3 | 0.3 | 0.3 | 0.5 | 0.5 | 0.5 | 0.5 | 0.5 |
| Citric Acid | 1 | 1 | 0 | 1.5 | 1 | 1 | 0 | 0 |
| Lactic Acid | 0.85 | 0.85 | 1 | 0.85 | 1.5 | 1.5 | 2 | 2 |
| C8-10 Alkyl Polyglucoside | 1.5 | 2 | 2 | 2 | 2.2 | 2.2 | 2.2 | 2.2 |
| 1,3 Propanediol | 5 | 5 | 5 | 10 | 10 | 10 | 10 | 10 |
| Ethanol | 0.5 | 0.5 | 0.5 | 0.5 | 0.5 | 0.5 | 0.5 | 0.5 |
| Potassium Sorbate | 0 | 0.2 | 0.2 | 0 | 0 | 0.2 | 0 | 0.2 |
| Sodium Benzoate | 0.25 | 0.3 | 0.3 | 0.5 | 0.5 | 0.3 | 0.5 | 0.3 |
| Fragrance | 0.35 | 0.35 | 0.35 | 0.35 | 0.35 | 0.35 | 0.35 | 0.35 |
| pH | 3.16 | 3.28 | 3.84 | 3.40 | 3.33 | 3.32 | 3.55 | 3.54 |

TABLE 4B

| | Contact | | Control | Log₁₀ | |
|---|---|---|---|---|---|
| Formula AC1612 | Time | Soil | Carrier | Reduction | |
| AC1612-A | 9 min | 5% FBS | 5.10 Log₁₀ | 1.36 | Log₁₀ |
| AC1612-B | 9 min | 5% FBS | 5.10 Log₁₀ | 1.89 | Log₁₀ |
| AC1612-C | 9 min | 5% FBS | 5.10 Log₁₀ | 2.83 | Log₁₀ |
| AC1612-D | 9 min | 5% FBS | 7.01 Log₁₀ | 1/10 | Fail |
| AC1612-E | 9 min | 5% FBS | 6.90 Log₁₀ | 10/10 | Fail |
| AC1612-F | 9 min | 5% FBS | 6.90 Log₁₀ | 10/10 | Fail |
| AC1612-G | 9 min | 5% FBS | 6.90 Log₁₀ | 10/10 | Fail |
| AC1612-H | 9 min | 5% FBS | 6.90 Log₁₀ | 10/10 | Fail |

As shown in Table 4A, cleaning formulations AC1612 A-H include from 0% to 1.5% citric acid in combination with 0.85% to 2% lactic acid. Additionally, cleaning formulations AC16012 A-H include various other adjuncts as shown.

Table 4B shows antimicrobial efficacy results when testing the cleaning formulations AC1612 A-H against Staph. aureus. As shown, each formulation failed and did not achieve the desired threshold level of soft surface disinfection within the 9-minute contact time.

TABLE 5A

| | Formula AC1613 | | | | | | | | |
|---|---|---|---|---|---|---|---|---|---|
| | A | B | C | D | E | F | G | H | J |
| Ingredient | % w/w | % w/w | % w/w | % w/w | % w/w | % w/w | % w/w | % w/w | % w/w |
| DI Water | to 100 | to 100 | to 100 | to 100 | to 100 | to 100 | to 100 | to 100 | to 100 |
| Sodium Citrate | 0.3 | 0.2 | 0.3 | 0.2 | 0.4 | 0.4 | 0 | 0.6 | 0.5 |
| Dihydrate | | | | | | | | | |
| Citric Acid | 1.5 | 2.5 | 2 | 2.75 | 3.5 | 3 | 2 | 3.5 | 4 |
| Lactic Acid | 1.5 | 1.5 | 2 | 0 | 0 | 0.8 | 0 | 1.2 | 0.8 |
| C8-10 Alkyl | | | | | | | | | |
| Polyglucoside | 1.75 | 1.75 | 1.75 | 1.75 | 1.75 | 1.75 | 2.3 | 1.75 | 2 |
| 1,3 Propanediol | 20 | 15 | 20 | 15 | 15 | 15 | 20 | 15 | 15 |
| Ethanol | 0.5 | 0.5 | 0.5 | 0.5 | 0 | 0 | 0 | 0 | 0 |
| Potassium Sorbate | 0.2 | 0 | 0 | 0 | 0 | 0 | 0 | 0.2 | 0 |
| Sodium Benzoate | 0.3 | 0.3 | 0.3 | 0.5 | 0.3 | 0.3 | 1 | 0 | 0.3 |
| Fragrance | 0.35 | 0.35 | 0.35 | 0.35 | 0.35 | 0.35 | 0.35 | 0.35 | 0.35 |
| pH | 3.12 | 2.84 | 2.87 | 3.02 | 2.9 | 2.87 | 3.49 | 2.85 | 2.81 |

TABLE 5B

| | Contact | | Control | Log₁₀ | |
|---|---|---|---|---|---|
| Formula AC1613 | Time | Soil | Carrier | Reduction | |
| AC1613-A | 9 min | 5% FBS | 6.31 Log₁₀ | 5.56 | Log₁₀ |
| AC1613-A | 9 min | 5% FBS | 6.31 Log₁₀ | 8/10 | Fail |
| AC1613-B | 9 min | 5% FBS | 6.67 Log₁₀ | 7/10 | Fail |
| AC1613-C | 9 min | 5% FBS | 6.67 Log₁₀ | 9/10 | Fail |
| AC1613-D | 9 min | 5% FBS | 6.67 Log₁₀ | 6/10 | Fail |
| AC1613-E | 9 min | 5% FBS | 6.72 Log₁₀ | 10/10 | Fail |
| AC1613-F | 9 min | 5% FBS | 6.72 Log₁₀ | 5/10 | Fail |
| AC1613-G | 9 min | 5% FBS | 6.72 Log₁₀ | 10/10 | Fail |
| AC1613-H | 9 min | 5% FBS | 6.61 Log₁₀ | 5/10 | Fail |
| AC1613-J | 9 min | 5% FBS | 6.61 Log₁₀ | 6/10 | Fail |

As shown in Table 5A, cleaning formulations AC1613 A-J include 1.5% to 4% citric acid in combination with 0% to 2% lactic acid. Additionally, cleaning formulations AC1613 A-J include various other adjuncts as shown.

Table 5B shows antimicrobial efficacy results when testing the cleaning formulations AC1613 A-J against Staph. aureus. As shown, each formulation failed and did not achieve the desired threshold level of soft surface disinfection within the 9-minute contact time. Generally speaking, it was further noted that relatively high levels of 1,3 propanediol (e.g., 15-20%) negatively impacted the antimicrobial efficacy of the cleaning formulation.

TABLE 6A

| | Formula AC1615 | | | | |
|---|---|---|---|---|---|
| | A | B | C | D | E |
| Ingredient | % w/w | % w/w | % w/w | % w/w | % w/w |
| DI Water | to 100 | to 100 | to 100 | to 100 | to 100 |
| Sodium Citrate Dihydrate | 0.3 | 0.3 | 0.3 | 0.3 | 0.3 |
| Citric Acid | 1.5 | 1.5 | 1.5 | 1.5 | 3 |
| Lactic Acid | 1.5 | 1.5 | 1.5 | 1.5 | 1 |
| C8-10 Alkyl | 0 | 0 | 1.5 | 0 | 1.75 |
| Polyglucoside | | | | | |
| C12-14 secondary | 2 | 2 | 0 | 0 | 0 |
| alcohol ethoxylate | | | | | |
| Lauramine Oxide | 0 | 0.33 | 0.4 | 4 | 0.4 |
| 1,3 Propanediol | 12 | 12 | 12 | 12 | 10 |
| Ethanol | 0.5 | 0.5 | 0.5 | 0.5 | 0.5 |
| Potassium Sorbate | 0.2 | 0.2 | 0.2 | 0.2 | 0 |
| Sodium Benzoate | 0.3 | 0.3 | 0.3 | 0.3 | 0.5 |
| Fragrance | 0.35 | 0.35 | 0.35 | 0.35 | 0.35 |
| pH | 3.13 | 3.19 | 3.19 | 3.29 | 2.92 |

TABLE 6B

| | Contact | | Control | Log₁₀ | |
|---|---|---|---|---|---|
| Formula AC1615 | Time | Soil | Carrier | Reduction | |
| AC1615-A | 9 min | 5% FBS | 6.30 Log₁₀ | 3.86 | Log₁₀ |
| AC1615-B | 9 min | 5% FBS | 6.30 Log₁₀ | 4.64 | Log₁₀ |
| AC1615-C | 9 min | 5% FBS | 6.63 Log₁₀ | 5.50 | Log₁₀ |
| AC1615-D | 9 min | 5% FBS | 6.63 Log₁₀ | 5.08 | Log₁₀ |
| AC1615-E | 9 min | 5% FBS | 6.66 Log₁₀ | >6.65 | Log₁₀ |

As shown in Table 6A, cleaning formulations AC1615 A-E include from 1.5 to 3% citric acid in combination with 1% to 1.5% lactic acid. Additionally, cleaning formulations AC1615 A-Es include various adjuncts as shown.

Table 6B shows antimicrobial efficacy results when testing the cleaning formulations AC1615 A-E against Staph. aureus. As shown, each of formulations AC1615 A-D failed and did not achieve the desired threshold level of soft surface disinfection within the 9 minute contact time. Surprisingly, cleaning formulation AC1615-E passed and achieved the desired threshold level of soft surface disinfection.

In other words, soft surface disinfection was achieved with a combination of about 3% citric acid, about 1% lactic acid, and about 0.5% sodium benzoate. Additionally, the results show that ethoxylated surfactants have a negative impact on the antimicrobial efficacy of the cleaning formulation. The results show synergistic, surprising results for a 3:1 ratio of citric acid to lactic acid in combination with sodium benzoate, as achieving at least a 6 log reduction in soft surface disinfection.

TABLE 7A

| | Formula 1622 | | | | |
|---|---|---|---|---|---|
| | A | B | C | D | E |
| Ingredient | % w/w | % w/W | % w/w | % w/w | % w/w |
| DI Water | to 100 | to 100 | to 100 | to 100 | to 100 |
| Sodium Citrate Dihydrate | 0.3 | 0.3 | 0.3 | 0.3 | 0.3 |
| Citric Acid | 3 | 3 | 3 | 3 | 3 |
| Lactic Acid | 1 | 1 | 1 | 1 | 1 |
| C8-10 Alkyl | 3 | 3 | 2.3 | 2.4 | 2.6 |
| Polyglucoside | | | | | |
| Lauramine Oxide | 0.4 | 0 | 0.4 | 0 | 0.4 |
| Sodium Lauryl Sulfate | 0 | 0.12 | 0 | 0.12 | 0 |
| Ethanol | 0.6 | 0.5 | 0.5 | 0.5 | 0.5 |
| Sodium Benzoate | 0.5 | 0.5 | 0.3 | 0.3 | 0.3 |
| Sodium Bicarbonate | 0 | 0 | 0 | 0 | 0.5 |
| Fragrance | 0.35 | 0.35 | 0.35 | 0.35 | 0.35 |
| pH | 2.86 | 2.83 | 2.69 | 2.66 | 3.11 |

TABLE 7B

| | Contact | | Control | Log₁₀ |
|---|---|---|---|---|
| Formula | Time | Soil | Carrier | Reduction |
| AC1622-A | 9 min | 5% FBS | 6.10 Log₁₀ | >6.10 Log₁₀ |
| AC1622-B | 9 min | 5% FBS | 6.10 Log₁₀ | >6.10 Log₁₀ |
| AC1622-C | 9 min | 5% FBS | 6.10 Log₁₀ | >6.10 Log₁₀ |
| AC1622-D | 9 min | 5% FBS | 6.10 Log₁₀ | >6.10 Log₁₀ |
| AC1622-E | 9 min | 5% FBS | 6.10 Log₁₀ | >6.10 Log₁₀ |

As shown in Table 7A, cleaning formulations AC1622 A-E include 3% citric acid in combination with 1% lactic acid in further combination with 0.3% to 0.5% sodium benzoate. Additionally, the cleaning formulations include one or more of alkyl polyglucoside, lauramine oxide, and/or sodium lauryl sulfate.

Table 7B shows results for testing the cleaning formulations AC1622 A-E against Staph. aureus. As shown, all cleaning formulation passed and achieved the desired threshold level of soft surface disinfection. Additionally, the results show that nonionic surfactants (e.g., non-ethoxylated nonionic surfactants) in combination with another surfactant (e.g., a cationic or anionic surfactant) has a positive impact on the antimicrobial efficacy of the cleaning formulation.

TABLE 8A

| | Formula AC1624 | | | | |
|---|---|---|---|---|---|
| | A | B | C | D | E |
| Ingredient | % w/w | % w/w | % w/w | % w/w | % w/w |
| DI Water | to 100 | to 100 | to 100 | to 100 | to 100 |
| Sodium Citrate Dihydrate | 0.5 | 0.5 | 0.5 | 0.5 | 0.5 |
| Citric Acid | 3 | 3 | 3 | 3 | 2.5 |
| Lactic Acid | 1 | 0 | 0.8 | 0.5 | 0.8 |
| C8-10 Alkyl | 2.5 | 2.5 | 2.3 | 2.3 | 2.3 |
| Polyglucoside | | | | | |
| Lauramine Oxide | 0.4 | 0.3 | 0 | 0.3 | 0.3 |
| Ethanol | 0.5 | 0.5 | 0.5 | 0.5 | 0.5 |
| Sodium Benzoate | 0 | 0.3 | 0.3 | 0.3 | 0.3 |
| Fragrance | 0.35 | 0.35 | 0.35 | 0.35 | 0.35 |
| pH | 2.69 | 2.97 | 2.79 | 2.87 | 2.96 |

TABLE 8B

| | Contact | | Control | Log₁₀ | |
|---|---|---|---|---|---|
| Formula AC1624 | Time | Soil | Carrier | Reduction | |
| AC1624-A | 9 min | 5% FBS | 6.03 Log₁₀ | 3.85 | Log₁₀ |
| AC1624-B | 9 min | 5% FBS | 6.03 Log₁₀ | 5.54 | Log₁₀ |
| AC1624-C | 9 min | 5% FBS | 6.03 Log₁₀ | >5.97 | Log₁₀ |
| AC1624-D | 9 min | 5% FBS | 6.03 Log₁₀ | >5.91 | Log₁₀ |
| AC1624-E | 9 min | 5% FBS | 6.03 Log₁₀ | 5.40 | Log₁₀ |

As shown in Table 8A, cleaning formulations AC1624 A-E include 2.5% to 3% citric acid in combination with 0% to 1% lactic acid in further combination with 0% to 0.3% sodium benzoate. Additionally, the cleaning formulations include alkyl polyglucoside, lauramine oxide and/or other adjuncts as shown.

Table 8B shows results for testing the cleaning formulations AC1622 A-E against Staph. aureus. As shown, all cleaning formulation failed to achieve the desired threshold level of soft surface disinfection. That said, some were very close to achieving a 6-log reduction, as shown. Additionally, the results show that a specific ratio and minimum percentage of citric acid in combination with sodium benzoate can be important to achieving the desired level of soft surface disinfection.

TABLE 9A

| | Formula AC1625 | | | | |
|---|---|---|---|---|---|
| | A | B | C | D | E |
| Ingredient | % w/w | % w/w | % w/w | % w/w | % w/w |
| DI Water | to 100 | to 100 | to 100 | to 100 | to 100 |
| Sodium Citrate Dihydrate | 0.5 | 0.5 | 0.5 | 0.5 | 0.5 |
| Citric Acid | 3 | 3 | 3 | 2.5 | 2.5 |
| Lactic Acid | 1 | 0.8 | 0.5 | 0.5 | 0.5 |
| C8-10 Alkyl | 2.2 | 2.3 | 2.3 | 2.3 | 2.3 |
| Polyglucoside | | | | | |
| Lauramine Oxide | 0 | 0.3 | 0 | 0 | 0 |
| Sodium Benzoate | 0.3 | 0.3 | 0.3 | 0.3 | 0.3 |
| Sodium Bicarbonate | 0 | 0 | 0 | 0 | 0.3 |
| Fragrance | 0.35 | 0.35 | 0.35 | 0.35 | 0.35 |
| pH | 2.83 | 2.94 | 2.88 | 3.02 | 3.33 |

TABLE 9B

| | Contact | | Control | Log₁₀ | |
|---|---|---|---|---|---|
| Formula AC1625 | Time | Soil | Carrier | Reduction | |
| AC1625-A | 9 min | 5% FBS | 6.20 Log10 | 5.40 | Log₁₀ |
| AC1625-B | 9 min | 5% FBS | 6.20 Log10 | >6.20 | Log₁₀ |
| AC1625-C | 9 min | 5% FBS | 6.20 Log10 | >6.20 | Log₁₀ |
| AC1625-D | 9 min | 5% FBS | 6.20 Log10 | >6.20 | Log₁₀ |
| AC1625-E | 9 min | 5% FBS | 6.20 Log10 | 6.08 | Log₁₀ |

As shown in Table 9A, cleaning formulations AC1625 A-E include 2.5% to 3% citric acid in combination with 0.5% to 1% lactic acid in further combination with 0.3% sodium benzoate. Additionally, the cleaning formulations optionally include alkyl polyglucoside, lauramine oxide, and/or other adjuncts as shown.

Table 9B shows results for testing the cleaning formulations AC1625 A-E against Staph. aureus. As shown, cleaning formulations AC1625-A and AC1625-E failed and did not achieve the desired threshold level of soft surface disinfection, although cleaning formulations AC1625 B-D passed and did achieve the desired threshold level of soft surface disinfection. The results show that soft surface disinfection can be achieved with at least about 2.5% citric acid in combination with about 0.5% lactic acid, in further combination with about 0.3% sodium benzoate. In other words, the results show that cleaning compositions with a 5:1 ratio of citric acid to lactic acid with sodium benzoate can advantageously and surprisingly achieve soft surface disinfection. A comparison of formulations AC1625-D and AC1625-E shows that it may be beneficial to limit or omit any include bicarbonate (e.g., sodium bicarbonate).

TABLE 10A

| | Formula AC1626 | | | | |
|---|---|---|---|---|---|
| | A | B | C | D | E |
| Ingredient | % w/w | % w/w | % w/w | % w/w | % w/w |
| DI Water | to 100 | to 100 | to 100 | to 100 | to 100 |
| Sodium Citrate Dihydrate | 0.5 | 0.5 | 0.5 | 0.5 | 0.5 |
| Citric Acid | 3 | 2.5 | 2.5 | 2.5 | 2 |
| Lactic Acid | 0 | 0.5 | 0 | 0 | 1 |
| C8-10 Alkyl | 2.4 | 1.5 | 1.5 | 2.5 | 2.4 |
| Polyglucoside | | | | | |
| Sodium Benzoate | 0.3 | 0.3 | 0.3 | 0.3 | 0.3 |
| Sodium Bicarbonate | 0.3 | 0 | 0.5 | 0.5 | 0.5 |
| Fragrance | 0.35 | 0.35 | 0.35 | 0.35 | 0.35 |
| pH | 3.29 | 3.03 | 3.64 | 3.60 | 3.50 |

TABLE 10B

| | Contact | | Control | Log₁₀ | |
|---|---|---|---|---|---|
| Formula AC1626 | Time | Soil | Carrier | Reduction | |
| AC1626-A | 9 min | 5% FBS | 5.83 Log10 | 5.77 | Log₁₀ |
| AC1626-B | 9 min | 5% FBS | 5.83 Log10 | >5.83 | Log₁₀ |
| AC1626-C | 9 min | 5% FBS | 5.83 Log10 | 4.66 | Log₁₀ |
| AC1626-D | 9 min | 5% FBS | 5.83 Log10 | 4.95 | Log₁₀ |
| AC1626-E | 9 min | 5% FBS | 5.83 Log10 | 4.89 | Log₁₀ |

As shown in Table 10A, cleaning formulations AC1626 A-E include 2% to 3% citric acid in combination with 0% to 1% lactic acid in further combination with 0.3% sodium benzoate. Additionally, the cleaning formulations optionally include alkyl polyglucoside and/or other adjuncts as shown.

Table 10B shows results for testing the cleaning formulations AC1626 A-E against Staph. aureus. As shown, cleaning formulations AC1626-A and AC1626 C-E failed and did not achieve a 5.8 log threshold level of soft surface disinfection. As also shown, cleaning formulation AC1626-B passed and did achieve such a threshold level of soft surface disinfection.

TABLE 11A

| | Formula AC1642 | | |
|---|---|---|---|
| | A | C | D |
| Ingredient | % w/w | % w/w | % w/w |
| DI Water | to 100 | to 100 | to 100 |
| Sodium Citrate Dihydrate | 0.5 | 0.5 | 0.5 |
| Citric Acid | 2.5 | 2.5 | 3 |
| Lactic Acid | 0.5 | 0.5 | 0 |
| C8-10 Alkyl Polyglucoside | 0 | 0 | 2.5 |
| Lauramine Oxide | 0 | 0 | 0.3 |
| Sodium Lauryl Sulfate | 0 | 6.67 | 0 |
| C12-14 secondary alcohol ethoxylate | 2 | 0 | 0 |
| Sodium Benzoate | 0.3 | 0.3 | 0.3 |
| Fragrance | 0.35 | 0.35 | 0.35 |
| pH | 2.78 | 2.77 | 3.02 |

TABLE 11B

| | Contact | | Control | Log₁₀ |
|---|---|---|---|---|
| Formula AC1642 | Time | Soil | Carrier | Reduction |
| AC1642-A | 9:30 min | 5% FBS | 5.73 Log₁₀ | 4.15 Log₁₀ |
| AC1642-C | 9:30 min | 5% FBS | 6.14 Log₁₀ | 6.13 Log₁₀ |
| AC1642-D | 9:30 min | 5% FBS | 6.14 Log₁₀ | 5.73 Log₁₀ |

As shown in Table 11A, cleaning formulations AC1642-A, AC1642-C, and AC1642-D include 2.5% to 3% citric acid in combination with 0% to 0.5% lactic acid in further combination with 0.3% sodium benzoate. Additionally, the cleaning formulations include one or more of alkyl polyglucoside, lauramine oxide, sodium lauryl sulfate, and/or secondary alcohol ethoxylate as shown.

Table 11B shows results for testing the cleaning formulations AC1642-A, AC1642-C, and AC1642-D against Staph. aureus. As shown, cleaning formulations AC1642-A and AC1642-D failed and did not achieve a desired 6-log threshold level of soft surface disinfection. As also shown, cleaning formulation AC1642-C passed and did achieve a 6-log level of soft surface disinfection.

TABLE 12A

Formula AC1645

| | A | C |
|---|---|---|
| Ingredient | % w/w | % w/w |
| DI Water | to 100 | to 100 |
| Sodium Citrate Dihydrate | 0.5 | 0.5 |
| Citric Acid | 2.5 | 2.5 |
| Lactic Acid | 0.5 | 0.5 |
| C8-10 Alkyl Polyglucoside | 1.5 | 0 |
| Sodium Lauryl Sulfate | 0 | 4 |
| C12-14 secondary alcohol ethoxylate | 2 | 0 |
| Sodium Benzoate | 0.3 | 0.3 |
| Fragrance | 0.35 | 0.35 |
| pH | 2.92 | 2.85 |

TABLE 12B

| | Contact | | Control | Log₁₀ |
|---|---|---|---|---|
| Formula 1645 | Time | Soil | Carrier | Reduction |
| AC1645-A | 9:30 min | 5% FBS | 6.55 Log₁₀ | 4.08 Log₁₀ |
| AC1645-C | 9:30 min | 5% FBS | 6.55 Log₁₀ | 6.54 Log₁₀ |

As shown in Table 12A, cleaning formulations AC1645-A and AC1645-B include 2.5% to 3% citric acid in combination with 0% to 0.5% lactic acid in further combination with 0.3% sodium benzoate. Additionally, the cleaning formulations optionally include one or more of alkyl polyglucoside, sodium lauryl sulfate, and/or secondary alcohol ethoxylate as shown.

Table 12B shows results for testing the cleaning formulations AC1645-A and AC1645-B against Staph. aureus. As shown, cleaning formulation AC1645-A failed and did not achieve a 6-log threshold level of soft surface disinfection and cleaning formulation AC1645-B passed and did achieve a 6-log level of soft surface disinfection. Again, the inclusion of an ethoxylate surfactant is associated with failure to achieve the desired threshold level of disinfection.

TABLE 13A

| | Formula AC1628 | | | |
|---|---|---|---|---|
| | E | F | G | H |
| Ingredient | % w/w | % w/w | % w/w | % w/w |
| DI Water | to 100 | to 100 | to 100 | to 100 |
| Sodium Citrate Dihydrate | 0.05 | 0.2 | 0 | 0 |
| Citric Acid | 2.5 | 2.5 | 2.7 | 2.5 |
| Lactic Acid | 0.6 | 0.5 | 0.5 | 0.5 |
| C8-10 Alkyl Polyglucoside | 2.04 | 2.4 | 2.4 | 2.4 |
| Lauramine Oxide | 0 | 0.3 | 0 | 0.3 |
| Sodium Lauryl Sulfate | 0 | 0 | 0 | 0 |
| 1,3 Propanediol | 0 | 1 | 0 | 0 |
| Sodium Benzoate | 0.3 | 0.25 | 0.3 | 0.3 |
| Fragrance | 0.35 | 0.35 | 0.35 | 0.35 |
| pH | 2.45 | 2.63 | 2.4 | 2.57 |

TABLE 13B

| | Contact | | Control | Log₁₀ |
|---|---|---|---|---|
| Formula AC1628 | Time | Soil | Carrier | Reduction |
| AC1628-E | 9:30 min | 5% FBS | 6.55 Log₁₀ | >4.75 Log₁₀ |
| AC1628-F | 9:30 min | 5% FBS | 6.55 Log₁₀ | >4.25 Log₁₀ |
| AC1628-G | 9:30 min | 5% FBS | 6.25 Log₁₀ | >5.25 Log₁₀ |
| AC1628-H | 9:30 min | 5% FBS | 6.25 Log₁₀ | >3.75 Log₁₀ |

TABLE 13C

| | Contact | | Control | Log₁₀ |
|---|---|---|---|---|
| Formula AC1628 | Time | Soil | Carrier | Reduction |
| AC1628-E | 9:30 min | 5% FBS | 6.55 Log₁₀ | >3.75 Log₁₀ |
| AC1628-F | 9:30 min | 5% FBS | 6.55 Log₁₀ | >4.75 Log₁₀ |
| AC1628-G | 9:30 min | 5% FBS | 6.55 Log₁₀ | >4.75 Log₁₀ |
| AC1628-H | 9:30 min | 5% FBS | 6.55 Log₁₀ | >4.75 Log₁₀ |

As shown in Table 13A, cleaning formulations AC1628 E-H includes 2.5 to 2.7% citric acid in combination with 0.5% to 0.6% lactic acid in further combination with 0.3% sodium benzoate. Additionally, the cleaning formulations optionally included other adjuncts as noted.

Table 13B shows results for testing the cleaning formulations AC1628 E-H against Influenza A (H1N1). The threshold level of reduction for soft surface disinfection against H1N1 (and other viruses) is 3-log. As shown, all tested cleaning formulations AC1628 E-H passed.

Table 13C shows results for testing the cleaning formulations AC1628 E-H against Rhinovirus Type-39. As with H1N1, a 3-log reduction is required to achieve disinfection. As shown, all cleaning formulations AC1628 E-H passed.

Because soft surface disinfection is more difficult to achieve than similar disinfection on a hard non porous surface, those formulations that passed the applicable log reduction threshold for soft surface disinfection will pass a similar threshold level if tested on a hard non porous surface.

Additional exemplary formulas that could be tested in a similar manner are shown in Table 14.

TABLE 14

| | A | B | C | D |
|---|---|---|---|---|
| Ingredient | % w/w | % w/w | % w/w | % w/w |
| DI Water | to 100 | to 100 | to 100 | to 100 |
| Sodium Citrate Dihydrate | 0.5 | 0.5 | 0.5 | 0.5 |
| Citric Acid | 2.5 | 2.5 | 2.5 | 0 |
| Lactic Acid | 0.5 | 0.5 | 0.5 | 3 |
| C8-10 Alkyl Polyglucoside | 0 | 0 | 0 | 2.5 |
| Lauramine Oxide | 0 | 6.67 | 0 | 0.3 |
| C12-14 secondary | 2 | 0 | 0 | 0 |
| alcohol ethoxylate | | | | |
| Sodium Lauryl Sulfate | 0 | 0 | 6.67 | 0 |
| Sodium Benzoate | 0.3 | 0.3 | 0.3 | 0.3 |
| Fragrance | 0.35 | 0.35 | 0.35 | 0.35 |

In addition to hard and soft surface sanitization, the present formulations may also be useful in other cleaning, e.g., such as but not limited to general surface cleaning, anti-allergen treatments, air sanitization, fabric refreshing, and the like.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A cleaning formulation comprising:
(i) about 1% to about 5% by weight of citric acid;
(ii) about 0.1% to about 2% by weight of lactic acid;
(iii) about 0.01% to about 1% by weight of a preservative;
(iv) about 0.1% to about 5% by weight of at least one non-ethoxylated surfactant; and
(v) optionally, one or more adjuncts selected from: solvents, fragrances, preservatives, water, pH adjusting agents or any mixture or combination thereof,
wherein a ratio of citric acid to lactic acid is from about 3:1 to about 5:1 and the cleaning formulation exhibits at least a 3-log reduction in a Staphylococcus aureus population within 10 minutes.

2. The cleaning formulation of claim 1, wherein a pH of the cleaning formulation is about 2 to about 5.

3. The cleaning formulation of claim 1, wherein the at least one non-ethoxylated surfactant comprises a nonionic surfactant.

4. The cleaning formulation of claim 1, wherein the at least one non-ethoxylated surfactant comprises an anionic surfactant.

5. The cleaning formulation of claim 1, wherein the at least one non-ethoxylated surfactant comprises an amphoteric surfactant.

6. The cleaning formulation of claim 1, wherein the at least one non-ethoxylated surfactant comprises a sulfate.

7. The cleaning formulation of claim 1, wherein the at least one non-ethoxylated surfactant comprises an amine oxide.

8. The cleaning formulation of claim 1, wherein cleaning composition exhibits at least a 5-log reduction in Staphylococcus aureus population within 10 minutes.

9. The cleaning formulation of claim 1, wherein the preservative comprises sodium benzoate.

10. The cleaning formulation of claim 1, wherein cleaning composition exhibits at least a 3-log reduction in Staphylococcus aureus population on both hard and soft surfaces within 10 minutes.

11. The cleaning formulation of claim 10, wherein cleaning composition exhibits at least a 5-log reduction in Staphylococcus aureus population on both hard and soft surfaces within 10 minutes.

12. A cleaning formulation comprising:
(i) about 2% to about 4% by weight of citric acid;
(ii) about 0.1% to about 1% by weight of lactic acid;
(iii) about 0.01% to about 1% by weight of a benzoic acid or salt thereof;
(iv) about 0.1% to about 5% by weight of a nonionic, non-ethoxylated surfactant; and
(v) optionally, one or more adjuncts selected from: solvents, fragrances, preservatives, water, pH adjusting agents or any mixture or combination thereof,
wherein a ratio of citric acid to lactic acid is from about 3:1 to about 5:1 and the cleaning formulation exhibits at least a 3-log reduction in a Staphylococcus aureus population within 10 minutes.

13. The cleaning formulation of claim 12, further comprising a non-ethoxylated anionic surfactant.

14. The cleaning formulation of claim 13, wherein the non-ethoxylated anionic surfactant comprises a sulfate.

15. The cleaning formulation of claim 12, further comprising a non-ethoxylated amphoteric surfactant.

16. The cleaning formulation of claim 15, wherein the non-ethoxylated amphoteric surfactant comprises an amine oxide.

17. The cleaning formulation of claim 12, wherein the nonionic, non-ethoxylated surfactant comprises an alkyl polyglucoside.

18. A cleaning formulation comprising:
(i) about 2% to about 4% by weight of citric acid;
(ii) about 0.2% to about 1% by weight of lactic acid;
(iii) about 0.1% to about 0.8% by weight of a benzoic acid or salt thereof;
(iv) about 0.1% to about 5% by weight of a non-ethoxylated surfactant;
(v) about 2% to about 10% by weight of a solvent; and
(vi) optionally, one or more of adjuncts selected from: fragrances, preservatives, water, pH adjusting agents or any mixture or combination thereof,
wherein a ratio of citric acid to lactic acid is from about 3:1 to about 5:1 and cleaning formulation exhibits at least a 3-log reduction in a Staphylococcus aureus population within 10 minutes.

19. The cleaning formulation of claim 18, wherein the non-ethoxylated surfactant comprises at least one of an alkyl polyglucoside, an amine oxide, or a sulfate.

20. The cleaning formulation of claim 18, wherein the solvent comprises at least one of an alcohol or a diol.
